(19) United States
(12) Patent Application Publication
(10) Pub. No.: US 2017/0301429 A1
(43) Pub. Date: Oct. 19, 2017

(54) Insulation System

(71) Applicant: Siemens Aktiengesellschaft, Muenchen (DE)

(72) Inventors: Peter Groeppel, Erlangen (DE); Daniel Mach, Zirndorf (DE); Michael Nagel, Gremsdorf (DE); Gerhard Piecha, Nuernberg (DE); Christian Triebel, Nuernberg (DE); Matthias Uebler, Ursensollen (DE)

(73) Assignee: Siemens Aktiengesellschaft, Muenchen (DE)

(21) Appl. No.: 15/515,770

(22) PCT Filed: Sep. 22, 2015
(86) PCT No.: PCT/EP2015/071691

§ 371 Date: Mar. 30, 2017

(30) Foreign Application Priority Data
Sep. 30, 2014 (DE) 10 2014 219 765.1

(51) Int. Cl. H01B 3/40; H01B 3/28; H01B 3/00; H01B 3/46; C08L 63/00

(52) U.S. Cl. CPC H01B 3/40; H01B 3/46; C08L 63/00; H01B 3/002; H01B 3/28

(57) ABSTRACT

The present disclosure relates to insulation systems. Embodiments thereof may include a formulation for an insulation system used as casting resin and/or pressing resin as conductor and/or wall insulation for current-carrying conductors in generators, motors, and/or rotating machines. Some embodiments may include a material for use in an insulation system including: a base resin having one or more isotropic spherical filler fractions; wherein one of the one or more filler fractions comprises nanofiller particles comprising inorganic-organic particles; wherein both an inorganic fraction and an organic fraction are always simultaneously present; and the nanofiller particles comprise up to 25% by weight in the material.

### CROSS-REFERENCE TO RELATED APPLICATIONS

This application is a U.S. National Stage Application of International Application No. PCT/EP2015/071691 filed Sep. 22, 2015, which designates the United States of America, and claims priority to DE Application No. 10 2014 219 765.1 filed Sep. 30, 2014, the contents of which are hereby incorporated by reference in their entirety.

### TECHNICAL FIELD

The present disclosure relates to insulation systems. Embodiments thereof may include a formulation for an insulation system used as casting resin and/or pressing resin as conductor and/or wall insulation for current-carrying conductors in generators, motors, and/or rotating machines.

### BACKGROUND

In electric machines such as motors or generators, the reliability of the insulation system is critical for the operating safety thereof. The insulation system insulates electric conductors (wires, coils, rods) lastingly from one another and from the stator lamination packet or the surroundings. In high-voltage insulation, a distinction is made between insulation between subconductors (subconductor insulation), between the conductors and windings (conductor and/or winding insulation), and between conductors and mass potential in the groove and winding head region (main insulation). The thickness of the main insulation is matched both to the nominal voltage of the machine and to the operating and manufacturing conditions. Future plants for energy generation, their distribution, and use depends critically on the materials used and technologies employed for insulation. One fundamental problem in such electrically stressed insulators is partial discharge-induced erosion with formation of “treeing” channels which ultimately lead to electrical breakdown of the insulator.

In particular, the insulation system of the stator winding is greatly stressed by high thermal, thermomechanical, dynamic, and/or electromechanical operating stresses at the interface between the main insulation and the lamination packet of the stator winding. The risk of damage to the insulation system of the stator winding by partial discharge is unceasing during operation of the turbogenerator is high. The high-voltage insulation subject to great electric stresses at the interfaces is subject to materials degradation due to partial discharge-induced erosion.

### SUMMARY

There continues to be a need to provide insulation systems whose erosion resistance is optimized. Styrene and/or butadiene matrices having appropriate fillers have hitherto been used as fracture-mechanically resilient high-voltage insulators. The teachings of the present invention may provide a fracture-mechanically resilient high-voltage insulation system which displays improved erosion stability.

Some embodiments comprise a formulation for an insulation system including a base resin including one or more isotropic spherical filler components. In some embodiments, the filler components are nanoparticles comprising inorganic particles and organic particles. The nanoparticles may make up a total proportion of up to 25% by weight in the formulation.

Some embodiments may include a base resin comprising one or more isotropic spherical filler fraction(s). The filler fraction(s) comprise nanofiller particles which are at least partly inorganic-organic particles. An inorganic fraction and an organic fraction are always simultaneously present and the nanofiller particles are present in a total proportion of up to 25% by weight in the formulation.

In some embodiments, nanofiller particles of one nanofiller fraction are present in polymeric form.

In some embodiments, the nanofiller particles of one nanofiller fraction are based on inorganic-organic material.

In some embodiments, the inorganic-organic material comprises a styrene-butadiene component and/or a siloxane-butadiene component.

In some embodiments, the inorganic-organic material comprises a styrene-butadiene copolymer and/or a siloxane-butadiene copolymer.

In some embodiments, a nanofiller fraction comprising an inorganic-organic material is present in an amount of from 1 to 10% by weight.

Some embodiments include a nanofiller fraction composed of silicon dioxide.

In some embodiments, the nanofiller particles composed of silicon dioxide have an average diameter in the range from 7 to 17 nm, in particular from 8 to 15 nm.

Some embodiments may include an insulation system for a current-voltage conducting conductor composed of metal produced from a formulation as described above.

### BRIEF DESCRIPTION OF THE DRAWINGS

FIG. 1 includes a set of formulations that were tested, showing the resulting ductility and resilience of the polymers.

FIG. 2 shows the test results in respect of erosion resistance.

### DETAILED DESCRIPTION

Some embodiments may include an inorganic surface modification of the nanoparticles, to improve matrix-filler interaction. In some embodiments, the base resin is selected from the group consisting of thermoplastics, thermosets, and/or elastomers. The base resin can be selected from the group of UV-, cold- or hot-curing resins and resins which cure by means of phthalic anhydride and/or amines, e.g., an epoxy resin. In some embodiments, the base resin is a diglycidyl ether, for example a bisphenol A or bisphenol F diglycidyl ether or a cycloaliphatic epoxy resin or a phenolic novolac. Furthermore, the base resin can be selected from the group of polyurethanes, of polyetherimides, of polyethenes, of polypropylenes, of polybutadienes, of polystyrenes, of polyacrylates, of polyvinyl chlorides and any mixture thereof, for example including block polymers or block copolymers and blends of the abovementioned components, including the epoxy resins.

The isotropic fillers mentioned can be selected from the group consisting of inorganic particles, for example metallic, metal-oxidic and/or semimetal-oxidic particles. In some embodiments, the particles of the filler can also be composed of ceramic materials, for example a metal oxide or a metal mixed oxide, for example aluminum oxide and/or silicon dioxide. The inorganic nanofiller particles give the formulation the required erosion resistance.

In some embodiments, the particles of the filler can also be selected from the group consisting of organic compounds, for example they can be polymeric nanoparticles such as styrene, butadiene, etc. The organic nanofiller particles give the formulation a certain ductility.

In some embodiments, the organic fraction of the nanofiller particles is kept as small as possible. It is also possible to use CS particles (core-shell particles) as nanofiller particles. These are particles having a shell and a core composed of various materials. Core-shell particles generally have a layer structure which is composed of various materials and has a radial gradient.

A suitable surface modification ensures suitable bonding of the nanofiller particles to the matrix. The surface modification can be, for example, in the form of a coating.

The formulation may be used as fluid and/or isotropic material, with the nanofiller particles having dimensions in the range from 5 to 500 nm, from 7 to 350 nm, and/or in the range from 8 to 300 nm.

Some embodiments may include nanofiller particles based on silicon dioxide and/or based on inorganic-organic materials such as styrene-butadiene and/or based on siloxane-butadiene.

In some embodiments, a nanofiller fraction composed of inorganic-organic material is present in an amount of from 1 to 10% by weight, particularly preferably in an amount in the range from 3 to 8% by weight and particularly preferably from 4 to 6% by weight, in the formulation.

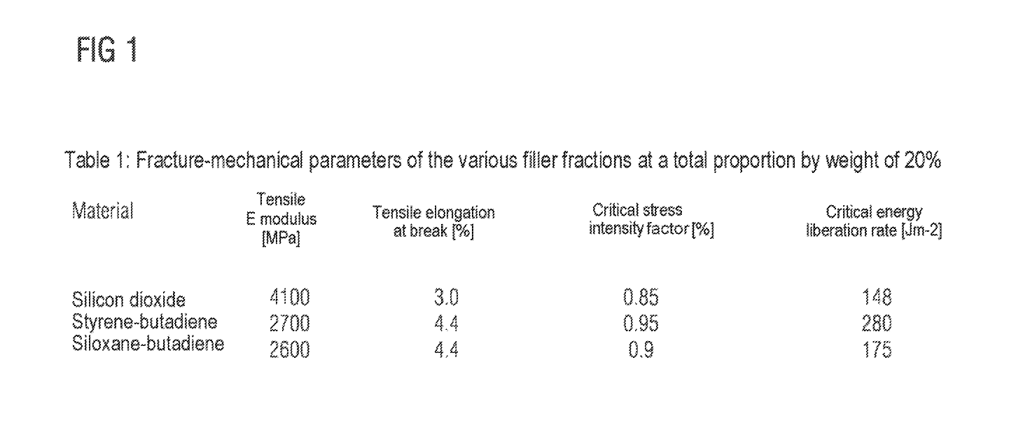

By way of example, the formulations shown in FIG. 1 were tested: It can be seen from table 1 in FIG. 1 that the increase in the ductility and resilience of the polymer by incorporation of organic nanofiller particles is more effective than by means of inorganic nanofiller particles. In the case of the organic nanofiller particle fraction, half of the inorganic nanofiller particles were replaced by organic analogs. The incorporation of organic nanofiller particles brings about a regression in the polymeric erosion resistance since the polymeric nature of this nanofiller fraction is subject to materials degradation under partial discharge stress.

Here, a transmission electron micrograph of a passivation layer, viewed from the side, of a polymer provided with a total proportion by weight of 10% of nanoparticulate filler showed that the passivation layer comprises fusion aggregates which are in turn composed of inorganic fillers connected via sinter bridges.

To increase the fracture-mechanical resilience, organic fillers were incorporated in the formulation.

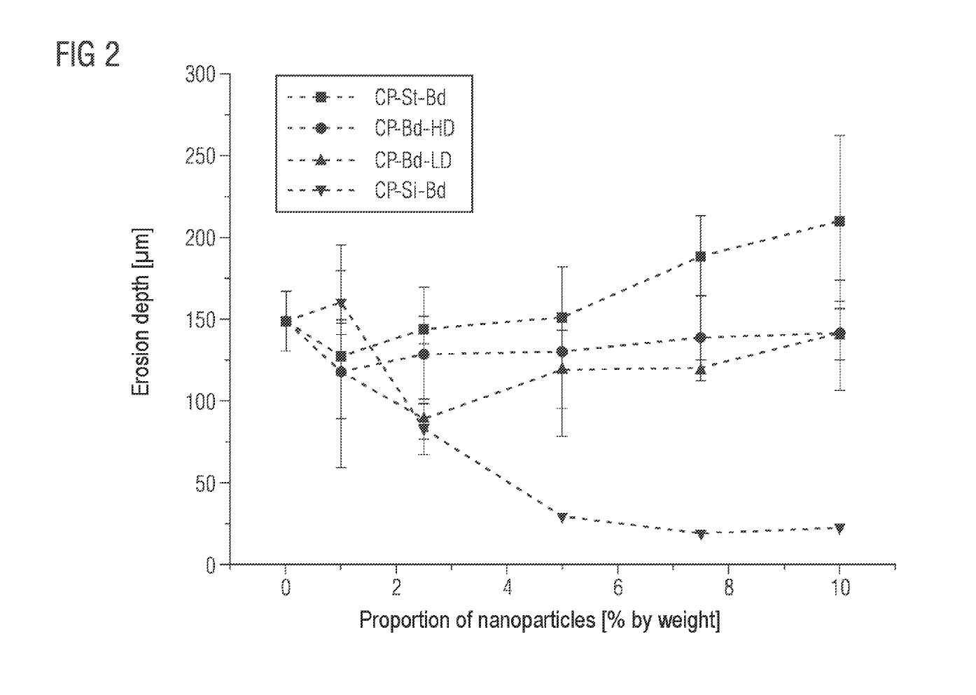

FIG. 2 shows the test results in respect of erosion resistance. As shown, there is a decrease in the erosion resistance over the course of gradually increased proportions by weight of organic nanofiller particles. Except for a nanofiller fraction (CP—Si-Bd=siloxane-butadiene), the organic fillers tested here bring about a decrease in the erosion resistance.

A transmission electron micrograph of a passivation layer of a polymer which contains styrene-butadiene nanofiller particles in addition to the 10% of inorganic nanofiller particles was subsequently taken. Compared to the first transmission electron micrograph, the significantly more inhomogeneous and more porous passivation layer could clearly be seen. The styrene-butadiene nanofiller particles function as barriers to the formation of the inorganic fusion aggregates, as a result of which the mechanical stability of the passivation layer is significantly lower, especially since the organic fillers are subject to materials degradation under partial discharge stress.

Finally, inorganic-organic nanofiller particles were used and a transmission electron micrograph of the passivation layer was again taken. The passivation layer concerned comprises silicon dioxide and siloxane-butadiene nanofiller particles in a total proportion by weight of 20%.

For the present purposes, an inorganic-organic material for a nanofiller particle is a material which firstly gives the formulation ductility and fracture resistance due to its organic fraction and secondly can form sinter bridges with the inorganic fusion aggregates of a passivation layer by means of the inorganic fraction of the formulation. For example, a styrene-butadiene material and/or a siloxane-butadiene material can be used here. In particular, a commercial siloxane-butadiene copolymer was successfully tested in an epoxy resin base polymer.

It can be seen in the transmission electron micrograph that the inorganic-organic nanofiller particles, for example the siloxane-butadiene nanofiller particles shown here, are integrated in a symbiotic manner into the passivation layer containing fusion aggregates since, due to their inorganic fraction, they likewise ensure sufficient bonding of the total passivation layer via sinter bridges as do the purely inorganic nanofiller particles. Despite the organic component in the nanofiller particles, the formulation comprising the inorganic-organic nanofiller particles displays a significantly more compact and homogeneous passivation layer than the formulation in which inorganic and organic nanofiller particles are present as separate fractions.

It can be seen that, due to the inorganic fraction of the siloxane-butadiene nanofiller particles, a symbiotic integration of this filler fraction into the passivation layer comprising inorganic fusion aggregates by means of sinter bridges occurs. The erosion resistance of this filler fraction generates a compact and homogeneous passivation layer, with the organic particles not being subject to any materials degradation under partial discharge stress and thus, in addition to the increased erosion resistance, a likewise fracture-mechanically resilient and ductile high-voltage insulator polymer system is formed.

### EXAMPLES

Resin: Bisphenol F diglycidyl ether,

Hardener: Methylhexahydrophthalic anhydride, ratio (resin to hardener) 1:0.9;

Accelerator: N,N-Dimethylbenzylamine, proportion of accelerator: 1% by weight,

Fillers: SiO₂ (d50=15 nm), SiO₂ (d50=8 nm), Kaneka-ACE MX-960 (siloxane-butadiene copolymer).
1st example: 20% by weight of SiO₂ (d50=15 nm)+5% by weight of MX-960
2nd example: 20% by weight of SiO₂ (d50=8 nm)+5% by weight of MX-960
3rd example: 15% by weight of SiO₂ (d50=15 nm)+5% by weight of SiO₂ (d50=8 nm)+5% by weight of MX-960

The present disclosure may provide a formulation for an insulation system, which displays greater erosion resistance and can be used as casting resin and/or pressing resin as conductor and/or wall insulation for current-carrying conductors in generators, motors and/or rotating machines. The formulation displays isotropic and spherical nanofiller particles in a proportion by weight of up to 25%, which have organic and inorganic fractions.

What is claimed is:

1. A material for use in an insulation system, the material comprising:
a base resin having one or more isotropic spherical filler fractions;
wherein one of the one or more filler fractions comprises nanofiller particles comprising inorganic-organic particles;
wherein both an inorganic fraction and an organic fraction are always simultaneously present; and
the nanofiller particles comprise up to 25% by weight in the material.

2. The material as claimed in claim 1, wherein the nanofiller particles comprise a polymeric form.

3. The material as claimed in claim 1, wherein the nanofiller particles comprise inorganic-organic material.

4. The material as claimed in claim 1, wherein the inorganic-organic particles comprise styrene-butadiene or siloxane-butadiene.

5. The material as claimed in claim 4, wherein the inorganic-organic particles comprise a styrene-butadiene copolymer or a siloxane-butadiene copolymer.

6. The material as claimed in claim 3, further comprising a nanofiller fraction of an inorganic-organic material present in an amount of from 1 to 10% by weight.

7. The material as claimed in claim 1, further comprising a nanofiller fraction of silicon dioxide.

8. The material as claimed in claim 7, wherein the nanofiller particles composed of silicon dioxide have an average diameter in the range from 7 to 17 nm, or from 8 to 15 nm.

9. An insulation system for a current-voltage conducting conductor, the insulation system comprising:
a base resin having one or more isotropic spherical filler fractions;
wherein one of the one or more filler fractions comprises nanofiller particles comprising inorganic-organic particles;
wherein both an inorganic fraction and an organic fraction are always simultaneously present; and
the nanofiller particles comprise up to 25% by weight in the material.
